(19) United States
(12) Patent Application Publication
(10) Pub. No.: US 2007/0153701 A1
(43) Pub. Date: Jul. 5, 2007

(54) Search determination module for a secondary network and corresponding method

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 11/323,498

(22) Filed: Dec. 31, 2005

(51) Int. Cl. H04J 1/16; H04L 12/28

(52) U.S. Cl. 370/252; 370/254

(57) ABSTRACT

A search determination module for a secondary network, wireless communication device, and corresponding method is provided for triggering the detection of a secondary network. The search determination module includes an ambient condition detector, such as a light detector, a temperature detector and/or a microphone, which is adapted to detect one or more characteristics associated with the ambient environment. The search determination module further includes a comparator for comparing at least one of the one or more detected characteristics associated with the ambient environment with a target value and producing a control signal used in the determination of triggering a search for the secondary network.

### FIELD OF THE INVENTION

The present invention relates generally to the scanning for a secondary network in a multi-mode communication environment, and more particularly, to the determination as to when a scan for a secondary network should be triggered.

### BACKGROUND OF THE INVENTION

The concept of multi-mode phones, while not new, continues to be of some interest. The various implementations have been received with varying degrees of success. Some earlier versions attempted to merge communication support for both portable devices which communicate via a cellular network and with a cordless telephone base, where it was believed that the potential cost savings associated with handling, where possible, calls via the cordless telephone base, with the flexibility of the wide area coverage of the cellular network, was going to be beneficial.

More recently, with the emergence of wireless local area networks (WLAN), such as 802.11 or Bluetooth, in places such as coffee shops, homes and at work, which support data communication via a packet data network, such as the Internet, as well as the emergence of voice over IP applications, there is a belief that a phone which more seamlessly supports both cellular communication connections and communication connections via a wireless local area network may be viewed by consumers as being beneficial.

However, at least one issue concerning dual mode operation between cellular networks (wide area networks—WANs) and wireless local area networks exists including knowing when to look for a local wireless access point, which supports the wireless local area network. This is true for dual mode systems such as UMA or SCAAN. It is undesirable to frequently look or scan for local access devices since every time a scan is performed, the scanning receiver subsystem needs to be activated, which can be detrimental to battery life. Furthermore, in many instances, the relatively more frequent scanning relative to a wireless local area network, may provide marginal benefits, in so far as often there may not be an accessible network to find, as wireless local area networks presently only provide fairly sporadic coverage in areas known as hot spots.

Various alternative suggestions have been made as to when to trigger a scan to see if a local access point for a wireless local area network exists. Unfortunately, these methods are often unreliable and cause too much triggering or not enough triggering. For example, one such proposal includes triggering a scan upon the detection of a significant change in the received signal strength of the received signal, which in at least some instances has produced results that are less than satisfactory.

Transitional regions of coverage, relative to wireless local area networks, can sometimes coincide with transitions into and out of some buildings. This is due in part because the walls of some buildings will partially shield the associated electromagnetic signals resulting in an attenuation of the signal at this point. The same can sometimes be the case with cellular communication coverage, where depending upon where you are located, reception may be difficult, for example in a basement or inside an elevator. Wireless local area network coverage can also often coincide with transitions into and out of a building, because the wireless local area network access points are typically privately owned for use in a home or a place of business, where users are likely to be present who want to have greater freedom in establishing communication access, which in turn allows for a degree of movement that is not limited by a requirement for a hard wired connection.

Consequently, the inventor has recognized that a system or method that makes better decisions concerning when to trigger a search for a secondary network, such as a wireless local area network access point would be beneficial. It would further be beneficial to associate this triggering with a transition between indoors and out of doors. As such, it may be beneficial to be able to detect changes in ambient environment conditions, consistent with when a mobile device is making such a transition, a device has substantially changed location, or a device is in an area having ambient environmental conditions that have been associated with previous successful attempts in locating a network of the desired type.

### SUMMARY OF THE INVENTION

The present invention provides a search determination module making a determination for triggering a search for a secondary network. The search determination module includes an ambient condition detector and a comparator, which is coupled to the ambient detector. The ambient condition detector is adapted for detecting one or more characteristics associated with an ambient condition. The comparator is adapted for receiving at least one or more characteristics associated with an ambient condition and comparing the at least one of the one or more characteristics to a target value, wherein depending upon the comparison of the at least one of the one or more ambient characteristics with a target value, the comparator will produce a control signal used in the determination of triggering a search for the secondary network.

In at least one embodiment, the ambient condition detector includes a light sensor.

In at least a further embodiment, the secondary network is a wireless local area network.

The present invention further provides for a wireless communication device, which has radio interface circuitry including at least one of a first receiver and a first transmitter for communicating with a primary network and at least one of a second receiver and second transmitter for communicating with a secondary network, and a search determination module used to trigger a search for the secondary network.

The present invention still further provides for a method including the detection of one or more characteristics associated with an ambient condition. The one or more detected characteristics associated with an ambient condition are then compared with a target value. A search for a secondary network is then triggered, based at least in part on the comparison of the detected one or more characteristics associated with an ambient condition to the target value.

These and other features, and advantages of this invention are evident from the following description of one or more preferred embodiments of this invention, with reference to the accompanying drawings.

### BRIEF DESCRIPTION OF THE DRAWINGS

FIG. 1 is a graphical overview of an exemplary communication environment including both a primary network and a secondary network;

FIG. 2 is a block diagram of a search determination module, in accordance with at least one embodiment of the present invention;

FIG. 3 is an exemplary graph illustrating normalized spectral irradiance as a function of wavelength for a plurality of different types of light;

FIG. 4 is an exemplary graph illustrating a percent total radiation as a function of wavelength bands for a plurality of different types of light;

FIG. 5 is a block circuit diagram of an exemplary circuit implementing a multi-color light sensor, in accordance with at least one embodiment of the present invention, which can be used in conjunction with the search determination module, illustrated in FIG. 2;

FIG. 6 is a block circuit diagram of an alternative light detection circuit;

FIG. 7 is a light detector element incorporating an array of light detecting elements and a corresponding filter associated with each of the elements in the array; and

FIG. 8 is a flow diagram for triggering a search for a secondary network, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

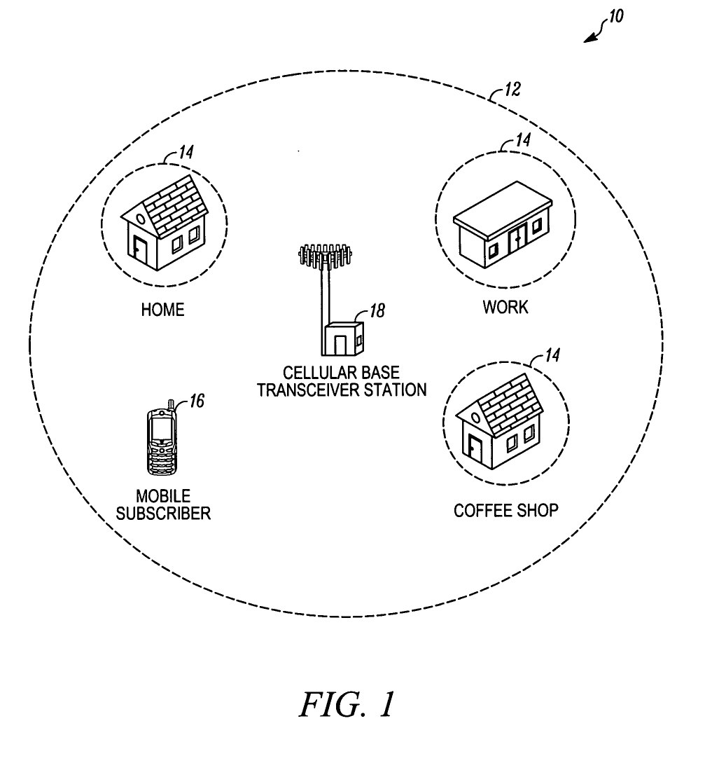

FIG. 1 illustrates a graphical overview 10 of an exemplary communication environment including both a primary network 12 and a secondary network 14. In the illustrated embodiment, the primary network corresponds to a wide area cellular network, such as a global system for mobile communications (GSM) for which coupling between the network and a multi-mode mobile subscriber 16 is facilitated through a cellular base transceiver station 18. However while a GSM type cellular network has been specifically identified, the alternative use of other types of networks is otherwise suitable without departing from the teachings of the present invention. In the illustrated embodiment, the secondary network corresponds to a wireless local area network, such as 802.11 or Bluetooth®, which as illustrated has multiple discontinuous zones of coverage. However, one skilled in the art will recognize that the teachings of the present invention could also be beneficially applied to still other types of networks including in some instances a cellular network as a secondary network.

In the illustrated embodiment, the cellular network is identified as the primary network, at least in part, because of the more complete coverage. However, even with relatively complete geographical coverage, a cellular network may still have areas, where signal reception is marginal or effectively non-existent. These types of regions are sometimes referred to as dead zones.

Whereas a wide area cellular network is traditionally managed by one or a relatively few number of network providers, each of the wireless local area coverage areas tend to be privately owned for purposes of supporting a particular geographical area, for which wider coverage beyond the boundaries of the owner's premises is generally not a priority. Because of this, there tends to be significant gaps in the network coverage of the wireless local area network 14, and even where coverage might exist, access may be restricted to only authorized individuals. Generally each area of coverage 14, corresponding to the secondary network is supported by one or more access nodes. Consequently, constant searching for a network only having limited amounts of localized coverage can often result in a waste of device resources, such as processing cycles and power usage, which might be expended supporting said searching.

As illustrated, coverage associated with wireless local area networks tend to be centered around a structure of some type. However, it is possible that coverage could exist independent of corresponding structure. Consequently, because wireless local area network coverage tends to be associated with a building, it may be beneficial to trigger a search for wireless local area network access points, when a device detects a change of position relative to a structure from between outside the structure and inside the structure.

Several types of detectable ambient conditions generally differ between inside of a structure and outside of a structure, which might be detectable for purposes of triggering a search for a secondary network. A couple of examples of detectable ambient conditions include lighting, sound and/or temperature. While the present disclosure focuses more on the detection of ambient lighting, one skilled in the art will readily appreciate that alternative ambient characteristics, such as those associated with sound and temperature, could also be used, either in place of, or as a supplement to lighting characteristics.

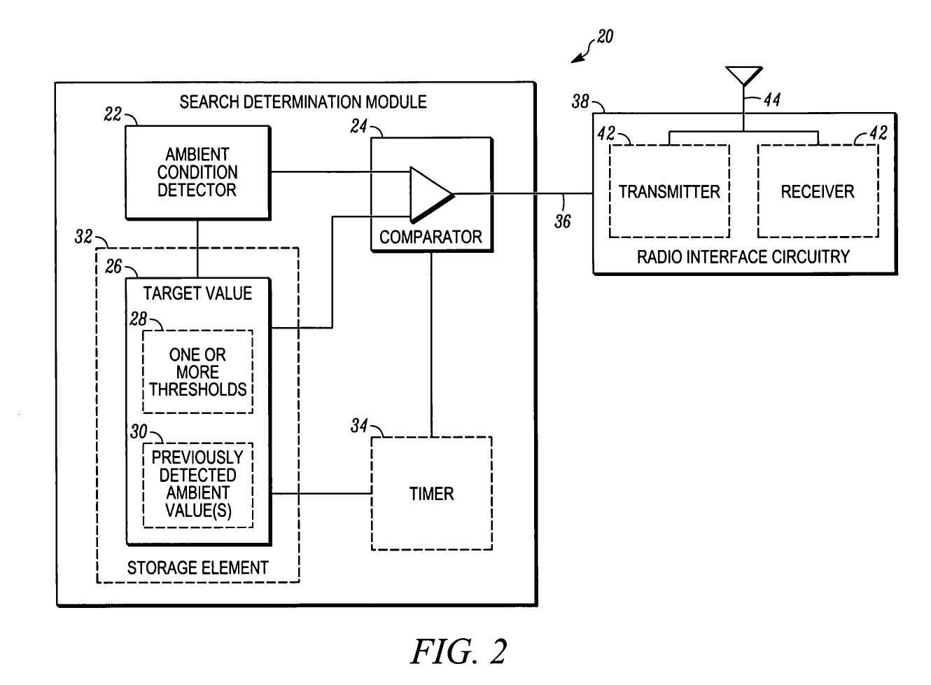

FIG. 2 illustrates a block diagram of a search determination module 20, which can be used to detect a change of location, based upon detected ambient conditions, such as lighting conditions, in accordance with at least one embodiment of the present invention. Generally, the search determination module will be associated with a device for which detection of the available communication networks, including the particular secondary network is desirable.

In the illustrated embodiment, the search determination module includes an ambient condition detector 22. As noted previously, the ambient condition detector might detect one or more various types of ambient conditions, such as lighting, temperature and/or sound. Many devices might already have elements incorporated therein, which would be suitable for detecting various ambient conditions. For example, a cellular telephone, which might support multiple-modes (i.e. access to multiple network types), may incorporate a camera having an image detector, which may be suitable to be used to detect one or more lighting characteristics of interest. Similarly, a cellular telephone generally incorporates a microphone, which also may be suitable relative to one or more sound characteristics. Alternatively, a dedicated detector for the express purpose of detecting ambient conditions, in connection with the present invention, could also be used.

The ambient condition detector is coupled to a comparator 24, which receives one or more characteristics associated with an ambient condition, and compares them against one or more target values 26. The one or more target values 26 might include one or more threshold values 28, and/or one or more previously detected ambient values(s) 30, and might be stored in a storage element 32, such as a semiconductor memory element, or other suitable form of storage. Values for various types of ambient condition characteristics will be identified to be associated with different types of environments, including those associated with being inside a structure and those associated with being outside a structure. For example inside a structure, the ambient light will generally include a larger percentage of light from man-made sources, such as fluorescent or incandescent light bulbs. While outside a structure, the ambient light will generally include a larger percentage of light from natural sources, such as the sun, at least during the day.

In some instances, one might detect the type of light being detected, and use the same to determine one's location relative to a structure (i.e. inside or outside). However, in other instances, one might merely look for a change in lighting conditions, which would be indicative of a meaningful change of location. In some instances (i.e. the former) it may be preferable to compare the presently or more recently measured ambient values to one or more predetermined thresholds, while in other instances (i.e. the latter) it may be preferable to compare the presently or more recently measured values to one or more previously measured values.

Still further, the search determination module 20 might include a timer 34, which can detect the current time or an amount of time that has elapsed between measurements. A current time might be used to determine which thresholds should be applied. For example, the thresholds associated with a detection of natural light from the sun, that one might detect while outdoors, may be different in the morning, than at the middle or the end of the day, or even at night. Furthermore, if no light is being detected in the middle of the day, it may be possible to assume that the device is contained in an enclosure that is precluding the ambient light from being received, which may be the case if the device is in a brief case, a purse, or possibly even a pocket. Such a case may be detectable by comparing against a still further threshold. In such an instance, the search determination module may alternatively monitor a different type of ambient condition, or might implement periodic checking for a second network access point, at a desired rate.

A detected change in ambient condition or a detected ambient condition that meets a set of one or more predetermined thresholds can be used to directly trigger a check. Alternatively, a detected change in ambient condition or a detected ambient condition that meets a set of one or more predetermined thresholds can be used to alter one or more parameters associated with a routine that performs periodic and/or regular checking. For example, depending on the nature of the condition detected, one might alter the frequency with which a search is performed.

Generally, the comparator produces a control signal 36, which can be used in connection with triggering a search. In the illustrated embodiment, the control signal 36 is received by the radio interface circuitry 38, but may be received by a controller (not shown), which could alternatively interact with the radio interface circuitry 38. In the illustrated embodiment, the radio interface circuitry 38 includes at least one of a transmitter 40 and a receiver 42, which in some instances may be formed together as part of a transceiver. In turn, the transmitter 40 and receiver 42 are coupled to an antenna 44.

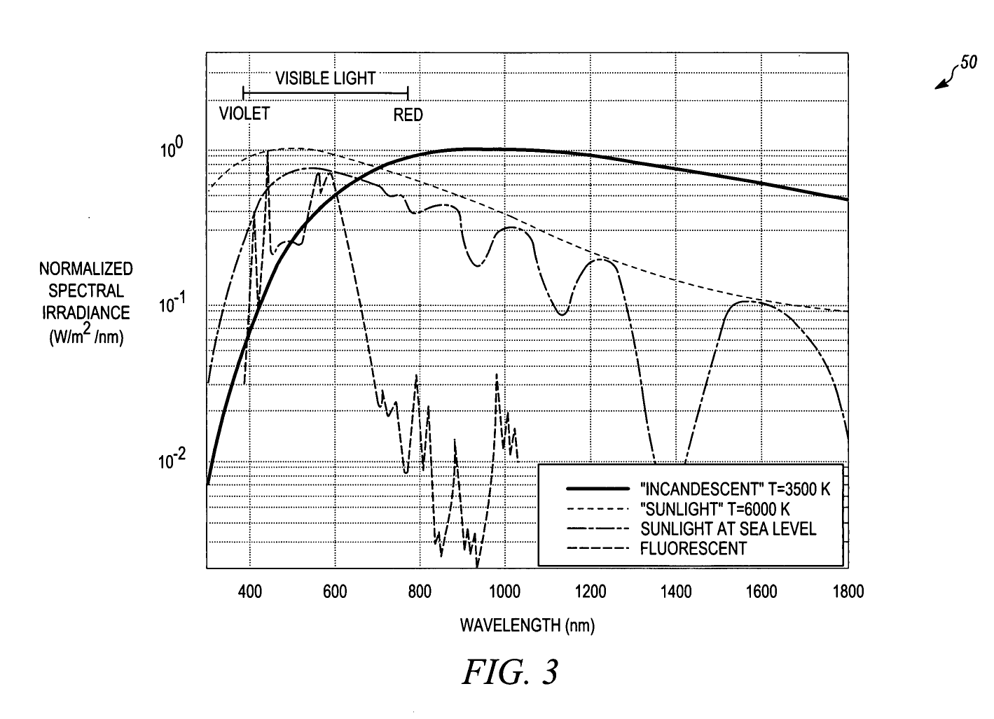

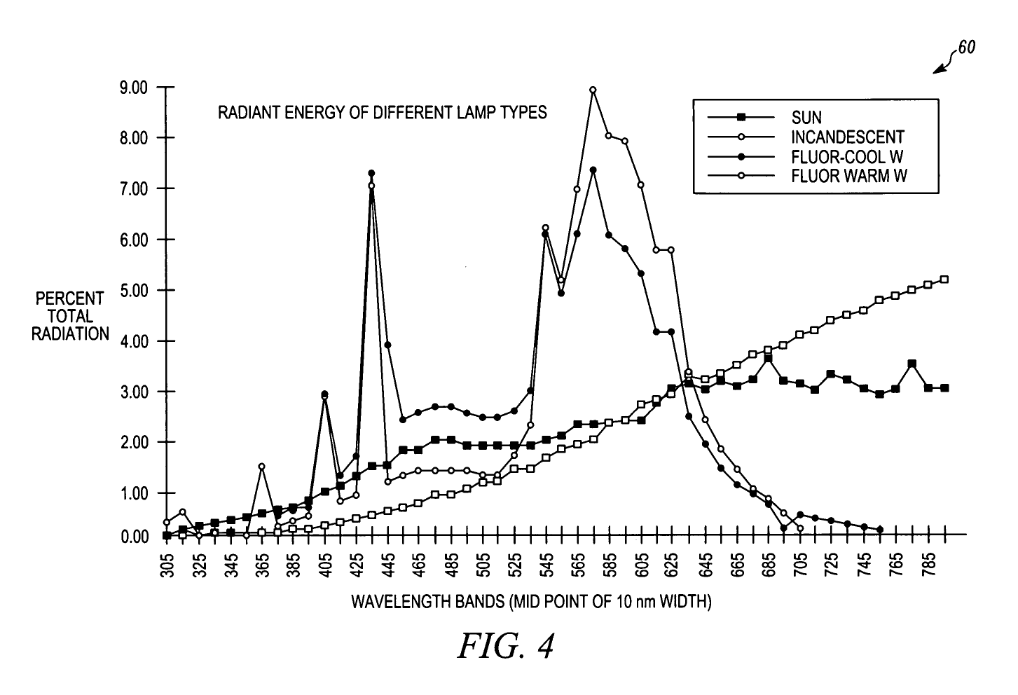

FIG. 3 is an exemplary graph 50 illustrating normalized spectral irradiance as a function of wavelength for a plurality of different types of light. In other words, the graph illustrates at least one example of a light characteristic, which might be detected, and which could be used to determine the type of lighting. FIG. 4 is a further exemplary graph 60 illustrating a percent total radiation as a function of wavelength for a plurality of different types of light, which might alternatively and/or additionally be used in connection with the comparison of the one or more detected characteristics. However, one skilled in the art will appreciate that still further suitable characteristics, and correspondingly representative data, might alternatively be used in connection with the comparison.

It is further possible, that the search determination module could store previously detected ambient condition values 30, and any corresponding successes or failures in connection with any related searches relative to a secondary access point, so that the information could be used to possibly match subsequently received ambient condition values, wherein the previous successes and failures might be used in the determination of whether, how or when to perform a search. For example, a particular user might experience a particular type of light almost exclusively at work, where secondary network coverage is provided. The device might be able to recognize the type of light and be able to determine that in the past, a detection of this type of light, generally, implies secondary network coverage exists, and as a result might immediately trigger a search for the secondary network or a sooner or more frequent search. In this way, a search can presumably be triggered more or less frequently, based upon a learned pattern, which can be used to identify a greater likelihood of success or failure to detect a secondary network.

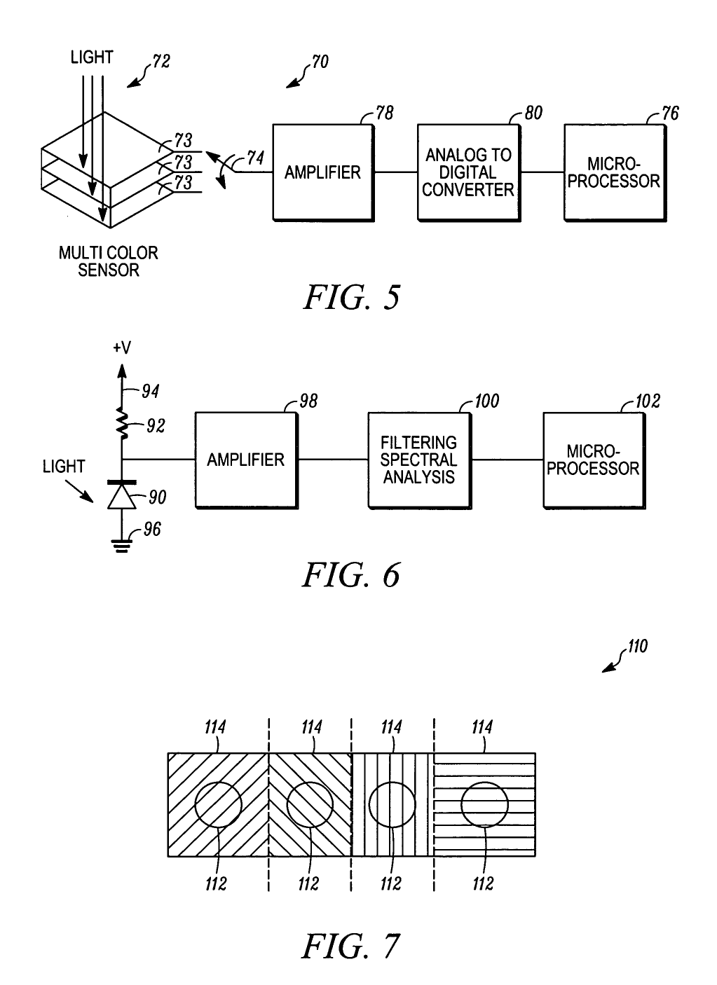

Relative to the detection of ambient light conditions, FIG. 5 is a block circuit diagram 70 of an exemplary circuit implementing a multi-color light sensor 72, in accordance with at least one embodiment of the present invention, which can be used in conjunction with the search determination module 20, illustrated in FIG. 2. The illustrated multi-color light sensor 72 includes a stack of sensor layers 73, which will receive varying amounts of the detected light dependent upon the corresponding make-up of the detected light. More specifically, higher frequency light waves having a higher energy content will generally be able to further penetrate the stacked structure. Consequently, the compositional make-up from each group of respective frequencies can be determined from an analysis of the amounts of detected light at each layer.

The amount of light detected at each layer can be selectively received and analyzed. In the illustrated embodiment a commutated input 74 selectively addresses each layer. In turn the detected signal is subsequently fed to a microprocessor 76 for processing via an amplifier 78 and an analog-to-digital converter 80. In some instances some or all of the post processing associated with the amplifier 78, the analog-to-digital converter 80 and the microprocessor can be implemented as part of either the ambient condition detector 22 or the comparator 24, and/or can be separately implemented.

FIG. 6 is a block circuit diagram of an alternative light detection circuit 90. In light detection circuit 90, a photo diode is illustrated, which is coupled in series with a resistor 92, with the non-common end of the resistor 92 being coupled to a supply voltage 94 and the cathode of the diode being coupled to ground 96. In photoconductive mode the diode is generally reverse-biased, and current generally flows in proportion to the intensity of the received light. The anode of the diode 90, which is coupled to one end of the resister 92, is additionally coupled to the input of an amplifier 98, which in turn is coupled to a filtering and spectral analysis module 100, which in turn is coupled to a microprocessor 102. Similarly, all or portions of the illustrated circuit elements could be incorporated as part of either ambient condition detector 22 or the comparator 24, and/or cam be separately implemented.

FIG. 7 is a light detector element 110 incorporating an array of light detecting elements 112 and a corresponding filter 114 associated with each of the elements in the array. The different hatching across each of the elements represents a filter having different transmissive properties, such that the magnitude of the light detected by each of the elements will be representative of a different set of corresponding characteristics of the detected light.

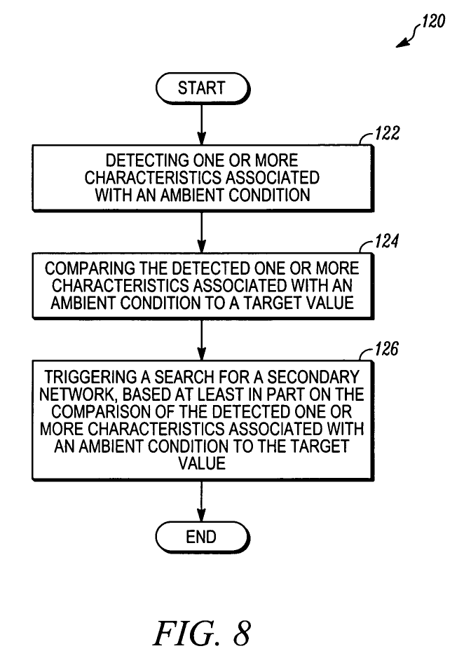

FIG. 8 is a flow diagram of a method 120 for triggering a search for a secondary network, in accordance with at least one embodiment of the present invention. The method includes detecting 122 one or more characteristics associated with an ambient condition. The one or more detected characteristics associated with the ambient condition is then compared 124 to a target value. A search for a secondary network is then triggered 126, based at least in part on the comparison 124 of the detected 122 one or more characteristics associated with an ambient condition to the target value.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A search determination module for a secondary network, the search determination module comprising:
an ambient condition detector for detecting one or more characteristics associated with an ambient condition; and
a comparator, coupled to the ambient condition detector, adapted for receiving at least one of the one or more characteristics associated with an ambient condition and comparing the at least one of the one or more characteristics to a target value, wherein depending upon the comparison of the at least one of the one or more ambient characteristic with a target value, the comparator will produce a control signal used in the determination of triggering a search for the secondary network.

2. A search determination module in accordance with claim 1, wherein the target value includes a first threshold having a predetermined value.

3. A search determination module in accordance with claim 1, wherein the target value includes a previously detected value of the at least one of the one or more characteristics associated with an ambient condition for detecting a meaningful change in the ambient environment.

4. A search determination module in accordance with claim 3 further comprising a clock circuit for detecting at least one of a time of day and an elapsed time between current and previously detected values of the at least one of the one or more characteristics associated with an ambient condition.

5. A search determination module in accordance with claim 4, wherein the comparator is coupled to the clock circuit for receiving an elapsed time between the current and previously detected values of the at least one of the one or more characteristics associated with an ambient condition in detecting a meaningful change.

6. A search determination module in accordance with claim 5, wherein the elapsed time between the current and previously detected values of the at least one of the one or more characteristics associated with an ambient condition is used in connection with detecting a meaningful change, where a change in the ambient environment having a rate of change below a predetermined value is filtered.

7. A search determination module in accordance with claim 5, wherein the elapsed time between the current and previously detected values of the at least one of the one or more characteristics associated with an ambient condition is used in connection with detecting a meaningful change, where a momentary change corresponding to a change in the ambient environment having a duration below a predetermined value is filtered.

8. A search determination module in accordance with claim 1, wherein the target value includes a composite of the one or more previously detected values of at least one of the one or more characteristics associated with an ambient condition.

9. A search determination module in accordance with claim 8, wherein the composite is an average of a predetermined number of the most recent one or more previous values.

10. A search determination module in accordance with claim 1, wherein the control signal produced by the comparator is used to trigger the search for the secondary network.

11. A search determination module in accordance with claim 1, wherein the control signal produced by the comparator is used to adjust the frequency at which the search for the secondary network is triggered.

12. A search determination module in accordance with claim 1 further comprising radio interface circuitry including at least one of a transmitter and a receiver for communicating with a secondary network.

13. A search determination module in accordance with claim 1 further comprising a storage element for storing one or more previous values.

14. A search determination module in accordance with claim 13, wherein the one or more previous values includes one or more previously detected one or more characteristics associated with a previous ambient condition.

15. A search determination module in accordance with claim 14 wherein the one or more previous values includes the results of a triggered search in association with the one or more previously detected characteristics associated with the previous ambient condition, which triggered the search.

16. A search determination module in accordance with claim 1, wherein the ambient condition detector includes a light sensor for detecting ambient lighting conditions.

17. A search determination module in accordance with claim 1, wherein the ambient condition detector includes a temperature sensor for detecting ambient temperature conditions.

18. A search determination module in accordance with claim 1, wherein the ambient condition detector includes a microphone for detecting ambient noise conditions.

19. A search determination module in accordance with claim 1, wherein the secondary network includes a wireless local area network.

20. A search determination module in accordance with claim 1, wherein the search determination module is incorporated as part of a wireless communication device.

21. A wireless communication device comprising:
radio interface circuitry including at least one of a first receiver and a first transmitter for communicating with a primary network, and at least one of a second receiver and a second transmitter for communicating with a secondary network; and
a search determination module for the secondary network including:
an ambient condition detector for detecting one or more characteristics associated with an ambient condition; and
a comparator, coupled to the ambient condition detector, adapted for receiving at least one or more characteristics associated with and an ambient condition and comparing the at least one of the one or more characteristics to a target value, wherein depending upon the comparison of the ambient characteristic with a target value, the comparator will produce a control signal used in the determination of triggering a search for the secondary network.

22. A method comprising:
detecting one or more characteristics associated with an ambient condition;
comparing the detected one or more characteristics associated with an ambient condition to a target value; and
triggering a search for a secondary network, based at least in part on the comparison of the detected one or more characteristics associated with an ambient condition to the target value.
